(19) United States
(12) Patent Application Publication
(10) Pub. No.: US 2017/0139291 A1
(43) Pub. Date: May 18, 2017

(54) LIQUID CRYSTAL DISPLAY DEVICE

(71) Applicant: Japan Display Inc., Minato-ku (JP)

(72) Inventors: Genki ASOZU, Tokyo (JP); Shigesumi ARAKI, Tokyo (JP)

(73) Assignee: Japan Display Inc., Minato-ku (JP)

(21) Appl. No.: 15/349,419

(22) Filed: Nov. 11, 2016

(30) Foreign Application Priority Data
Nov. 13, 2015 (JP) 2015-223086

(51) Int. Cl. G02F 1/1343; G02F 1/1362; G02F 1/1333; G09G 3/36; G02F 1/1339

(52) U.S. Cl. CPC G02F 1/134363; G09G 3/3674; G02F 1/1339; G02F 1/133345; G02F 1/136286; G09G 2300/0426; G02F 2201/121; G02F 2001/136218

(57) ABSTRACT

According to one embodiment, a liquid crystal display device includes a first substrate, a drive circuit, a second substrate, a sealing member, and a liquid crystal layer. The first substrate includes a first trap electrode provided in a non-display area, and a first shield electrode provided in the non-display area, located closer to a display area than the first trap electrode, and located above a scanning line. The drive circuit causes a potential of the first trap electrode to differ from a potential of the first shield electrode. The sealing member located opposite to at least part of the first trap electrode.

### CROSS-REFERENCE TO RELATED APPLICATIONS

This application is based upon and claims the benefit of priority from Japanese Patent Application No. 2015-223086, filed Nov. 13, 2015, the entire contents of which are incorporated herein by reference.

### FIELD

Embodiments described herein relate generally to a liquid crystal display device.

### BACKGROUND

A liquid crystal display device adapted for an in-plane switching (IPS) mode including a fringe field switching (FFS) mode, etc. includes an array substrate, a counter-substrate and a liquid crystal layer. In the array substrate, a driver circuit is provided, which applies a voltage to scanning lines and signal lines. Thus, in the array substrate, the scanning lines extend from a display area to the outside of the display area.

There is a case where ions are produced which are charged with impurities from the liquid crystal layer, an alignment film and a sealing member or impurities in water which enters the liquid crystal display device from the outside thereof. Such ions lower a voltage value, and thus cause black unevenness which lowers the brightness of the liquid crystal display device and causes a displayed image to look black. Those ions collect in the vicinity of portions of scanning lines which are located outside the display area, because of an electric field produced by the above portions of the scanning lines. If a large number of ions generate in the above manner, they flow into not only the outside of the display area but the inside of the display area.

Furthermore, as a method for effecting shielding against an electric field leaking from the portions of the scanning lines which are located outside the display area, it is known that the scanning lines which are located outside the display area are covered with a shield electrode in a region located above the scanning lines. It is possible to prevent occurrence of black unevenness by effecting electrical shielding against an electric field generated in the vicinity of the display area. This is because if an electric field is present in the vicinity of the display area, ions are localized in the display area, and black unevenness easily occurs. However, if a liquid crystal display device merely includes a shield electrode, it is hard to keep ions out of the display area, and ions can also flow into the display area.

### BRIEF DESCRIPTION OF THE DRAWINGS

FIG. 1 is a schematic view illustrating a liquid crystal display device according to a first embodiment.

FIG. 2 is a plan view illustrating an array substrate as illustrated in FIG. 1.

FIG. 3 is an enlarged plan view of part of the array substrate as illustrated in FIG. 2.

FIG. 4 is a cross-sectional view of the liquid crystal display device, which is taken along line IV-IV in FIG. 3.

FIG. 5 is an enlarged plan view of another part of the array substrate as illustrated in FIG. 2.

FIG. 6 is a cross-sectional view of the liquid crystal display device, which is taken along line VI-VI in FIG. 5.

FIG. 7 is another plan view of the array substrate.

FIG. 8 is an enlarged plan view of part of the array substrate as illustrated in FIG. 7.

FIG. 9 is a cross-sectional view of a liquid crystal display device according to a second embodiment.

FIG. 10 is a cross-sectional view of a liquid crystal display device according to a third embodiment.

FIG. 11 is a cross-sectional view of a liquid crystal display device according to a fourth embodiment.

FIG. 12 is a plan view of an array substrate as illustrated in FIG. 11.

FIG. 13 is an enlarged plan view of part of the array substrate as illustrated in FIG. 12.

FIG. 14 is a cross-sectional view of a liquid crystal display device according to a fifth embodiment.

FIG. 15 is a cross-sectional view of a liquid crystal display device according to a sixth embodiment.

FIG. 16 is a cross-sectional view of a liquid crystal display device according to a seventh embodiment.

FIG. 17 is a cross-sectional view of a liquid crystal display device according to an eighth embodiment.

FIG. 18 is a cross-sectional view of a liquid crystal display device according to a ninth embodiment.

FIG. 19 is a cross-sectional view of a liquid crystal display device according to a tenth embodiment.

### DETAILED DESCRIPTION

In general, according to one embodiment, there is provided a liquid crystal display device comprising: a first substrate including a display area which displays an image; a non-display area located outward of the display area; a scanning line provided to extend from the display area to the non-display area; a first trap electrode provided in the non-display area; and a first shield electrode provided in the non-display area, located closer to the display area than the first trap electrode, and located above the scanning line; a drive circuit which drives the scanning line, the first trap electrode and the first shield electrode, and causes a potential of the first trap electrode to differ from a potential of the first shield electrode; a second substrate located opposite to the first substrate; a sealing member located in the non-display area and opposite to at least part of the first trap electrode, and joining the first substrate and the second substrate to each other; and a liquid crystal layer held in space surrounded by the first substrate, the second substrate and the sealing member.

Hereinafter, embodiments will be explained with reference to accompanying drawings. The disclosure is a mere example, and arbitrary change of gist which can be easily conceived by a person of ordinary skill in the art naturally falls within the inventive scope. To better clarify the explanations, the drawings may pictorially show width, thickness, shape, etc. of each portion as compared with an actual aspect, but they are mere examples and do not restrict the interpretation of the invention. In the present specification and drawings, after structural elements are each explained once with reference to the drawings, there is a case where their explanations will be omitted as appropriate, and those identical to or similar to the explained structural elements will be denoted by the same reference numbers, respectively, as the explained structural elements.

### First Embodiment

A liquid crystal display device according to the first embodiment will be described.

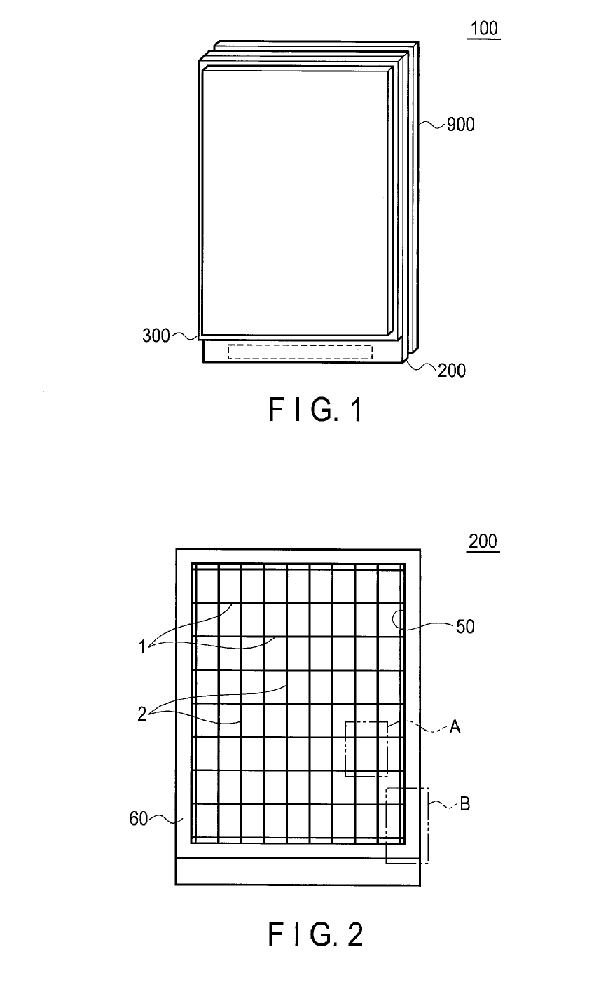

FIG. 1 is a perspective view of a liquid crystal display device 100. The liquid crystal display device 100 comprises an array substrate 200, a counter-substrate 300 and a backlight device 900, the array substrate 200 and the counter-substrate 300 being provided as a first substrate and a second substrate, respectively.

The backlight device 900 includes a light emitting unit such as a light emitting diode (LED), and emits light from a side located outward of the array substrate 200 such that the light is transmitted through the active-element substrate 200 and the counter-substrate 300.

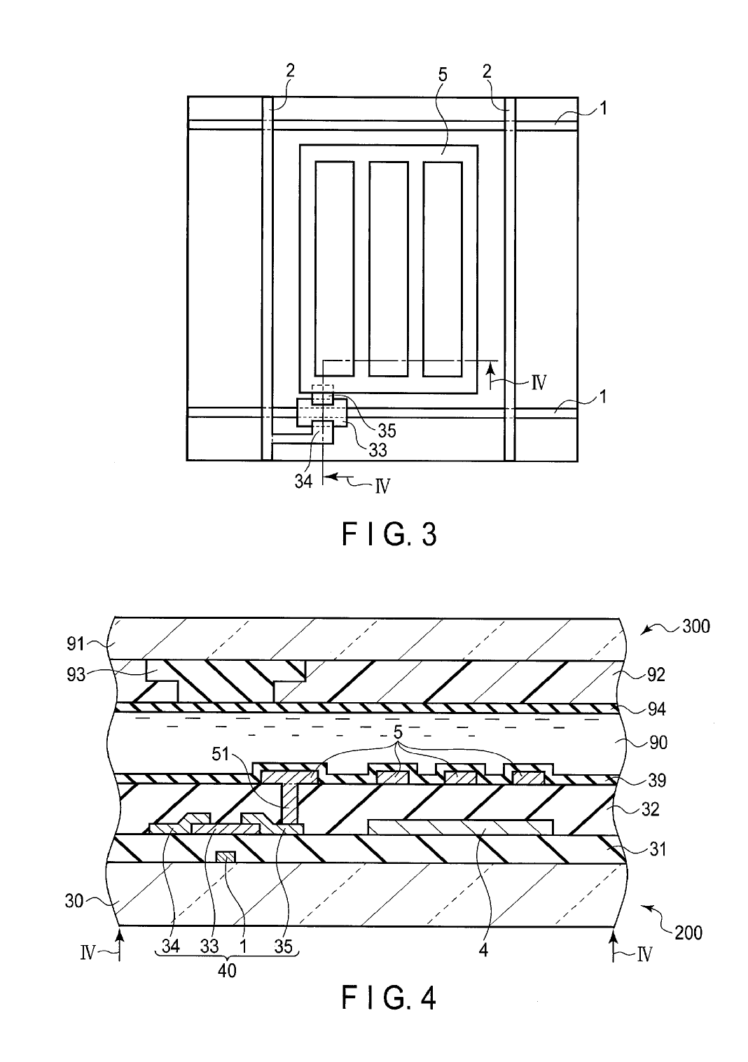

FIG. 2 is a plan view of the array substrate 200. FIG. 3 is an enlarged plan view illustrating part of the array substrate 200, i.e., an area A illustrated in FIG. 2. FIG. 4 is a cross-sectional view of the liquid crystal display device 100, which is taken along line IV-IV in FIG. 3.

In each of the embodiments, it is assumed that a direction from the counter-substrate 300 toward the array substrate 200 is a downward direction, and a direction from the array substrate 200 toward the counter-substrate 300 is an upward direction. It should be noted that referring to FIG. 3, the backlight device 900 is provided below the array substrate 200. The liquid crystal layer 90 is held between the array substrate 200 and the counter-substrate 300. The case where the liquid crystal display device 100 is seen from above in the downward direction will be explained using the expression “as seen in plan view”.

The array substrate 200 comprises scanning lines 1, signal lines 2, a common electrode 4, pixel electrodes 5, a transparent substrate 30, insulating layers 31 and 32, which are first and second insulating layers, respectively, semiconductor layers 33, source electrodes 34, drain electrodes 35 and an alignment film 39.

The transparent substrate 30 has insulation properties, and is formed of glass. However, it may be formed of plastic. Also, the transparent substrate 30 is, for example, rectangular.

The scanning lines 1 extend in a given direction with respect to the array substrate 200, and are arranged at regular intervals. The above given direction is, for example, a direction along short sides of the transparent substrate 30. Also, the scanning lines 1 are located above the transparent substrate 30. When a switching element 40 is in the on state, an associated scanning line 1 is given a gate high voltage which is higher than the voltage of the common electrode 4, and when the switching element 40 is in the off state, the scanning line 1 is given a gate low voltage which is lower than the voltage of the common electrode 4.

The signal lines 2 extend in another direction with respect to the array substrate 200, and are arranged at regular intervals. The above other direction is, for example, a direction along long sides of the transparent substrate 30. The given direction and the other direction are perpendicular to each other as seen in plan view, and the scanning lines 1 and the signal lines 2 cross each other. Each of the scanning lines 1 and the signal lines 2 may be partially bent. To the signal lines 2, a voltage is applied which varies in accordance with an image (video) to be displayed.

The insulating layer 31 is provided on the transparent substrate 30 and the signal lines 2. Between the transparent substrate 30 and the scanning lines 1, an undercoat film, an insulating layer or the like may be provided.

The common electrode 4 is provided on the insulating layer 31. The common electrode 4 is provided at least in the display area 50. In the first embodiment, the common electrode 4 is provided in a given direction throughout the display area 50. Also, the common electrode 4 is formed in the shape of a plate; however, it may be formed in the shape of a band. To the common electrode 4, a constant voltage is applied. The potential of the common electrode 4 is kept constant.

The semiconductor layers 33 are provided on the insulating layer 31. Each of the semiconductor layers 33 is provided above an associated scanning line 1, and is formed in the shape of a plate which has a greater width than the width of the scanning line 1 as seen in plan view. Each of the source electrodes 34 is provided on the insulating layer 31, and connected to one end side of an associated semiconductor layer 33. Each source electrode 34 is partially provided on the associated semiconductor layer 33. Each of the drain electrodes 35 is provided on the insulating layer 31, and connected to another end side of the associated semiconductor layer 33. Each drain electrode 35 is partially provided on the semiconductor layer 33. The above-mentioned scanning line 1, insulating layer 31, semiconductor layer 33, source electrode 34 and drain electrode 35 form a switching element 40.

The on/off state of the switching element 40 is controlled in accordance with a voltage applied to the scanning line 1. When the switching element 40 is in the on state, a voltage which varies in accordance with a voltage applied to an associated signal line 2 is applied to an associated drain electrode 35 through the above source electrode 34 and the semiconductor layer 33.

The insulating layer 32 is provided on the insulating layer 31, and covers the common electrode 4 and the switching elements 40. It should be noted that the insulating layers 31 and 32 may be provided so as not to contact each other, and another insulating layer, a color filter or the like may be provided between the insulating layers 31 and 32.

The insulating layers 31 and 32 are formed of respective insulating materials, and each comprise a single insulating layer or a plurality of insulating layers stacked together. For example, the insulating layer 31 comprises a single organic insulating layer, and the insulating layer 32 comprises a single inorganic insulating layer.

The pixel electrodes 5 are provided on the insulating layer 32, and formed in the shape of a plate. The pixel electrodes 5 include openings. In the first embodiment, in each of the pixel electrodes 5, three elongated openings are provided such that they extend substantially parallel to the signal lines, and are arranged and spaced from each other along the scanning lines 1. There is a case where the above openings will be referred to as slits. The pixel electrodes 5 may be formed in the shape of, for example, a band. Furthermore, each pixel electrode 5 includes a connection portion 51. The connection portion 51 projects downwards, and is electrically connected to the drain electrode 35. In the first embodiment, each pixel electrode 5 is connected to the drain electrode 35 through a contact hole formed in the insulating layer 32. Each pixel electrode 5 is given a voltage from the drain electrode 35. A voltage between each pixel electrode 5 and the common electrode 4 is applied to the liquid crystal layer 90.

The alignment film 39 is formed of, for example, polyimide, and causes a group of molecules of the liquid crystal layer 90 to be aligned in a specific direction.

The liquid crystal layer 90 is a nematic liquid crystal, and the alignment direction of its liquid crystal molecules varies in accordance with a voltage applied.

The array substrate 200 includes a display area 50 and a non-display area 60. In the display area 50, a plurality of switching elements 40 are provided. The backlight device 900 emits light onto a liquid display panel, and the switching elements 40 are controlled, thereby causing an image (video) to be displayed in the display area 50. In contrast, the non-display area 60 is located outward of the display area 50, and is an area in which an image (video) is not displayed. In the first embodiment, the display area 50 is rectangular, and the non-display area 60 is formed in the shape of a rectangular frame. However, their shapes are not limited to specific ones, and can be variously changed. For example, the display area 50 may be circular.

The counter-substrate 300 comprises a transparent substrate 91, a color filter 92, a light-shielding member 93 and an alignment film 94.

The transparent substrate 91 has insulation properties, and is formed of glass. However, it may be formed of plastic. The color filter 92 is provided under the transparent substrate 91, and permits light having a specific color to pass through the color filter 92. The light-shielding member 93 is provided under the transparent substrate 91. Furthermore, the light-shielding member 93 is formed in the shape of a lattice, located above the scanning lines 1 and the signal lines 2, and has a light blocking characteristic. The light-shielding member 93 may be provided in the non-display area 60. The alignment film 94 causes a group of liquid crystal molecules of the liquid crystal 90 to be aligned in a specific direction. It should be noted that in the case where the array substrate 200 includes a color filter, the counter-substrate 300 does not need to include the color filter 92 or the light-shielding member 93.

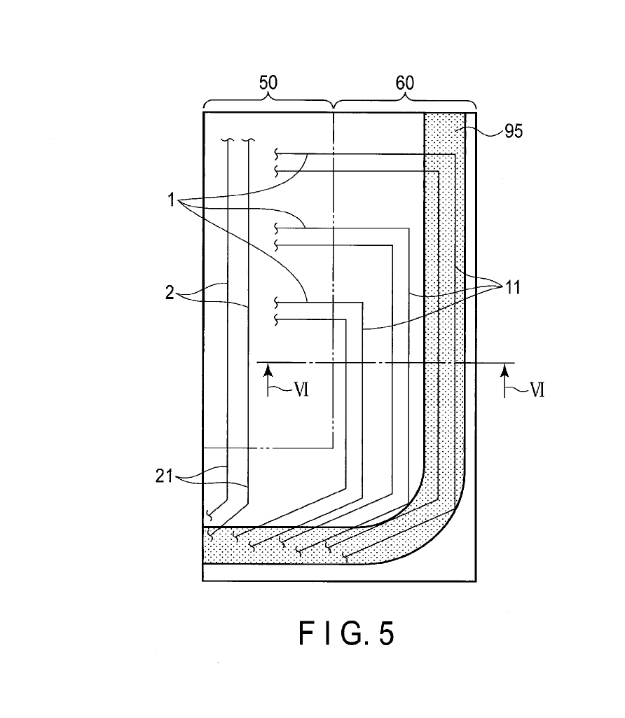

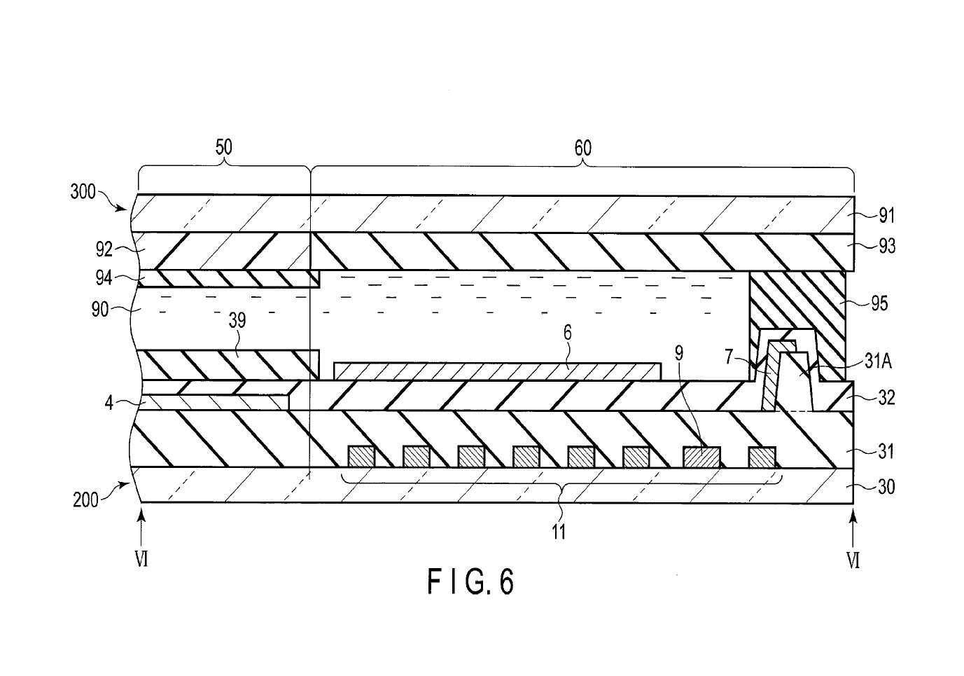

FIG. 5 is an enlarged plan view illustrating another part of the array substrate 200 according to the first embodiment, i.e., an area B illustrated in FIG. 2. FIG. 6 is a cross-sectional view of the liquid crystal display device 100, which is taken along line VI-VI in FIG. 5.

A sealing member 95 is provided in the non-display area 60 and along an outer peripheral portion of the non-display area 60. The sealing member 95 joins the array substrate 200 and the counter-substrate 300 to each other to seal space between these substrates, with the liquid crystal held between them. That is, the liquid crystal layer 90 is held in the space surrounded by the array substrate 200, the counter-substrate 300 and the sealing member 95. The sealing member 95 is located opposite to at least part of a trap electrode 7.

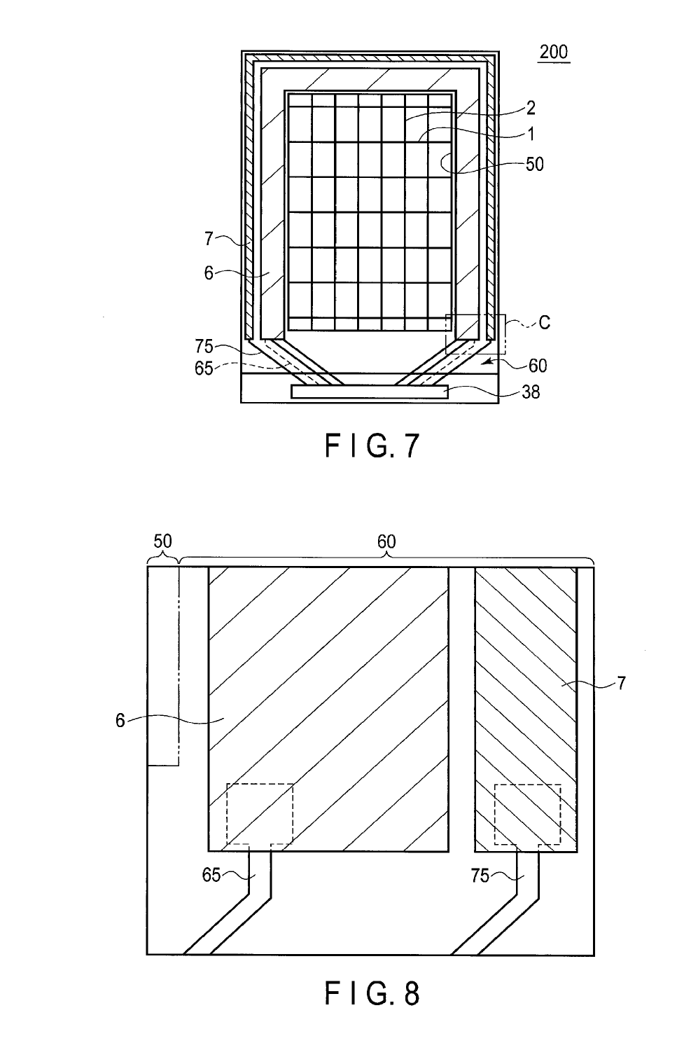

FIG. 7 is another plan view illustrating the array substrate 200 according to the first embodiment. FIG. 8 is an enlarged plan view illustrating part of the array substrate 200 as illustrated in FIG. 7, i.e., an area C illustrated in FIG. 7.

The scanning lines 1 are provided to extend from the display area 50 to the non-display area 60. Portions of the scanning lines 1 which are located in the non-display area 60 will be referred to as scanning lines 11. The scanning lines 11 of about half of the scanning lines 1 are located outward of one of the sides of the display area 50, and the scanning lines 11 of the other scanning lines 1 are located outward of another one of the sides of the display area 50. It should be noted that in the display area 50, the above one side of the display area 50 is located opposite to the above other side of the display area 50 in the direction of extension of the scanning lines 1.

The scanning lines 11 extend from the display area 50 to the non-display area 60 in the same direction as the scanning lines 1 in the display area 50, and are then bent to extend along the non-display area 60 and are spaced from each other. The distances between the scanning lines 11 are less than those between the scanning lines 1 in the display area 50. The scanning lines 11 are connected to a drive circuit 38. The scanning lines 1 are driven by the drive circuit 38. Some of the scanning lines 11 are also provided below the sealing member 95.

The signal lines 2 are provided to extend from the display area 50 to the non-display area 60. Portions of the signal lines 2 which are located in the non-display area 60 will be referred to as signal lines 21. The signal lines 21 are bent in the non-display area 60, and connected to the drive circuit 38. The signal lines 2 are driven by the drive circuit 38.

The drive circuit 38 is provided close to an edge of the array substrate 200. The drive circuit 38 applies a gate high voltage and a gate low voltage to the scanning lines 11. The drive circuit 38 applies a voltage (image signal) which varies in accordance with an image to be displayed, to the signal lines 21.

The insulating layer 31, the insulating layer 32 and the liquid crystal layer 90 are also provided in the non-display area 60.

A shield electrode 6, which is a first shield electrode, is provided on the insulating layer 32. That is, the shield electrode 6 is provided in the same layer as the alignment film 39. The shield electrode 6 is U-shaped along three sides of the non-display area 60, on which the drive circuit 38 is not provided; that is, it is U-shaped along the sides of the non-display area, except for a side on which the drive circuit 38 is provided. Also, the shield electrode 6 is located above the scanning lines 11 and opposite to the scanning lines 11. An inner edge of the shield electrode 6 is located closer to the display area 50 than the innermost one of the scanning line 11. The shield electrode 6 is separated from the sealing member 95. The shield electrode 6 may be formed of a conductive material such as indium tin oxide (ITO) or a conductive metal. The potential of the shield electrode 6 is set equal to that of the common electrode 4. In the first embodiment, the shield electrode 6 is electrically connected to the common electrode 4, and has the same potential as the common electrode 4.

A conductive line 65 connects the driving circuit 38 and the shielding electrode 6. The conductive line 65 may be connected to the common electrode 4.

As a first trap electrode, the trap electrode 7 is provided on the insulating layer 31 in the non-display area 60. That is, the trap electrode 7 is provided in the same layer as the common electrode 4. As seen in plan view, the trap electrode 7 is U-shaped along the three sides of the non-display area 60. Also, the trap electrode 7 is provided along the shield electrode 6. It should be noted that as seen in plan view, the shield electrode 6 is located closer to the display area 50 than the trap electrode 7.

The trap electrode 7 is located above the scanning lines 11 and opposite to the scanning lines 11. The trap electrode 7 may be formed of a transparent conductive material such as ITO or a conductive metal. The trap electrode 7 is provided below the sealing member 95. In the first embodiment, the sealing member 95 is located opposite to the entire trap electrode 7.

In the non-display area 60, a projection portion 31A is formed as a first projection portion, on the insulating layer 31. The projection portion 31A projects toward the counter-substrate 300. In the first embodiment, the projection portion 31A is formed integral with the insulating layer 31. In the case of forming the projection portion 31A, a well-known technique such as halftone exposure is applied, and the insulating layer 31 and the projection portion 31A can be formed at the same time. The projection portion 31A can be shaped in association with the shape of the shield electrode 6 or that of the trap electrode 7. For example, the projection portion 31A is U-shaped along the three sides of the non-display area 60 as seen in plan view.

The trap electrode 7 is provided above the insulating layer 31. The trap electrode 7 is also provided above the projection portion 31A. In the first embodiment, the trap electrode 7 is provided on the projection portion 31A. The trap electrode 7 is continuously formed from an upper surface of the projection portion 31A to a wall surface of the projection portion 31A which faces the display area 50. Thus, the trap electrode 7 can be formed along the projection portion 31A. The projection portion 31A and the trap electrode 7 are covered with the insulating layer 32.

A conductive line 75 connects the drive circuit 38 and the trap electrode 7 to each other. It should be noted that the drive circuit 38 drives the trap electrode 7. The drive circuit 38 causes the potential of the trap electrode 7 to differ from that of the shield electrode 6. In the first embodiment, the drive circuit 38 sets the potential of the trap electrode 7 at a lower value than the potential of the shield electrode 6. For example, the drive circuit 38 applies a gate low voltage which is an off voltage of the switching element 40 to the conductive line 75. The trap electrode 7 is set at a lower voltage value than the shield electrode 6.

The shield electrode 6 and the trap electrode 7 are separated from each other such that they are electrically insulated from each other. The shield electrode 6 and the trap electrode 7 are provided such that at least part of one of them does not cover at least part of the other, as seen in plan view. Also, preferably, the shield electrode 6 and the trap electrode 7 should be located so as not to overlap with each other, as seen in plan view. Also, preferably, the width of the trap electrode 7 should be less than that of an opening 61. Since the shield electrode 6 and the trap electrode 7 are provided such that at least part of one of them does not cover the other, as seen in plan view, the shield electrode 6 blocks ions existing as impurities, and the trap electrode 7 collects ions; that is, they can effectively fulfill their functions.

In the first embodiment, the array substrate 200 includes a trap electrode 9 as a second trap electrode. The trap electrode 9 is provided in the same layer as the scanning lines 11, and the trap electrode 9 and the scanning lines 11 are covered with the insulating layer 31. In the first embodiment, the trap electrode 9 is provided between scanning lines 11. Also, the trap electrode 9 is provided between the shield electrode 6 and the trap electrode 7 as seen in plan view. The trap electrode 9 can be formed of the same conductive material (for example, metal) as the scanning lines 11. The trap electrode 9 is provided in the same layer as the scanning lines 11. Thus, in the case of manufacturing the liquid crystal display device 100, the scanning lines 11 and the trap electrode 9 can be manufactured at a simple step. It should be noted that the trap electrode 9 may be formed of one or more low-voltage scanning lines the hourly-averaged voltage of which is lower than that of the common electrode 4.

The trap electrode 9 is electrically connected to the drive circuit 38. The drive circuit 38 drives the trap electrode 9. The drive circuit 38 causes the potential of the trap electrode 9 to differ from that of the shield electrode 6. In the first embodiment, the drive circuit 38 sets the potential of the trap electrode 7 at a lower value than the potential of the shield electrode 6. For example, the drive circuit 38 applies a gate low voltage which is an off voltage of the switching element 40 to the conductive line 75. The trap electrode 7 is set at a lower voltage value than the shield electrode 6. In this case, the trap electrodes 7 and 9 may be connected to each other not through the drive circuit 38. Since not only the trap electrode 7 but the trap electrode 9 traps ions, it is possible to effectively keep ions staying in the non-display area 60.

The trap electrode 9 can be shaped in association with the shape of the shield electrode 6 or that of the trap electrode 7. For example, as seen in plan view, the trap electrode 9 is U-shaped along the three sides of the non-display area 60. However, the shape of the trap electrode 9 is not limited to U-shape, and can be variously changed. It suffices that the trap electrode 9 is formed in at least part of the non-display area 60. In the case where the trap electrode 9 is formed of the above low-voltage scanning line or lines, it suffices that the trap electrode 9 is formed to extend along the scanning lines 11.

Also, the shapes of the projection portion 31A, the shield electrode 6 and the trap electrode 7 are not limited to U-shape, and can be variously changed. It suffices that the shield electrode 6 is located opposite to the scanning lines 11. Also, it suffices that the trap electrode 7 is formed in at least part of the non-display area 60, and an electric field can be produced between the trap electrode 7 and the shield electrode 6.

In the first embodiment, in the non-display area 60, the shield electrode 6 and the trap electrodes 7 and 9 are provided; and the shield electrode 6 has the same potential as the common electrode 4, and the trap electrodes 7 and 9 have potentials different from the potential of the common electrode 4. It is therefore possible to collect ions in the non-display area 60, while shielding the display area 50 against the ions.

In the first embodiment, ions charged with impurities, etc., are positive ions. Therefore, the potentials of the trap electrodes 7 and 9 are set lower than that of the common electrode 4, whereby the trap electrodes 7 and 9 can collect ions because of Coulomb force. It should be noted that in the case where ions charged with impurities, etc., are negative ions, the potentials of the trap electrodes 7 and 9 are set higher than that of the common electrode 4, whereby the trap electrodes 7 and 9 can collect ions.

At least part of the trap electrode 7 is located opposite to the sealing member 95. Thus, space in which ions can be trapped can be expanded to the vicinity of an inner peripheral wall of the sealing member 95, as compared with the case where the entire trap electrode 7 is located closer to the display area 50 than the sealing member 95. In the first embodiment, since the entire trap electrode 7 is located opposite to the sealing member 95, the space for trapping ions can be further expanded closer to the inner peripheral wall of the sealing member 95. Since a larger number of ions can be trapped, it is possible to prevent movement of some ions into the display area 50 and thus prevent occurrence of black unevenness.

The trap electrode 7 is provided above the projection portion 31A. The space for trapping ions can be expanded toward the counter-substrate 300, as compared with the case where the trap electrode 7 is not provided above the projection portion 31A. In such a manner, in the case where the trap electrode 7 is provided above the projection portion 31A, a larger number of ions can be trapped; that is, a more satisfactory advantage can be obtained than the above advantage.

Furthermore, the shield electrode 6 is provided on the insulating layer 32. That is, the shield electrode 6 is provided close to the liquid crystal layer 90. Thereby, the shield electrode 6 can effectively block ions generated from the liquid crystal layer 90.

Furthermore, the shield electrode 6 is located closer to the display area 50 than the trap electrodes 7 and 9. Thereby, the trap electrodes 7 and 9 can collect ions in positions located further away from the boundary between the display area 50 and the non-display area 60 than the shield electrode 6. It is therefore possible to effectively prevent ions from collecting in the display area 50.

Also, the shield electrode 6 is provided in an upper layer than a layer containing the trap electrode 9. Thereby, the shield electrode 6 can also effectively block ions existing on a side-surface side of the shield electrode 6, in addition to ions existing on an upper-surface side of the shield electrode 6.

In addition, part of the shield electrode 6 is provided in the same layer as the alignment film 39. Thus, the shield electrode 6 can effectively block ions produced from the alignment film 39.

By virtue of the above structure, it is possible to obtain a liquid crystal display device 100 in which ions can be kept out of the display area.

### Second Embodiment

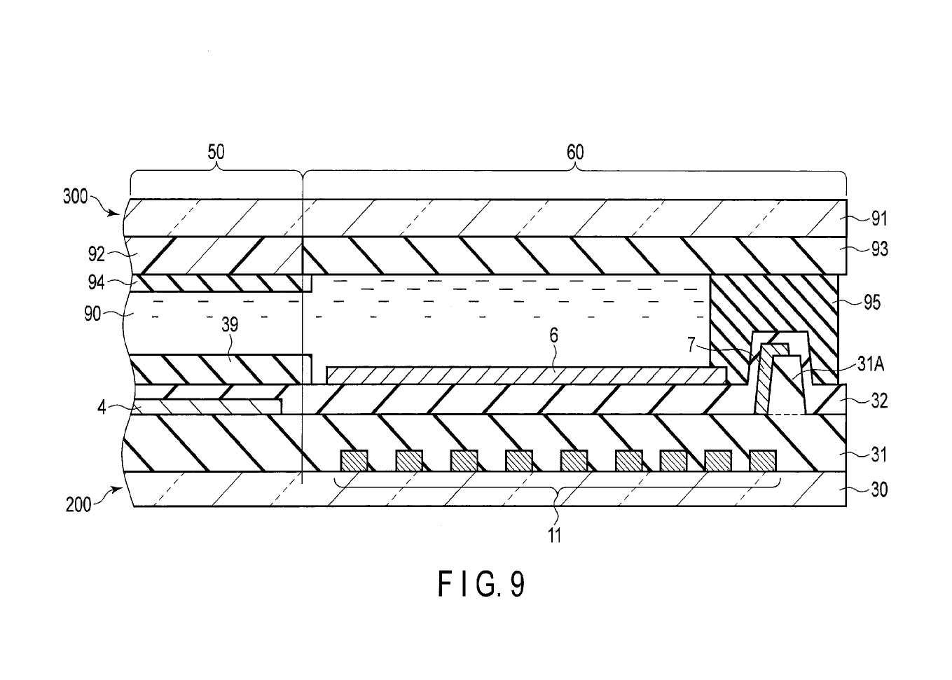

A liquid crystal display device according to the second embodiment will be described. FIG. 9 is a cross-sectional view illustrating the liquid crystal display device 100 according to the second embodiment.

As illustrated in FIG. 9, a trap electrode 7 is formed on a projection portion 31A, and the entire trap electrode 7 is located opposite to a sealing member 95, as in the first embodiment. However, unlike the first embodiment, an array substrate 200 is formed without including a trap electrode 9. A shield electrode 6 is provided on an insulating layer 32, and is expanded toward a trap electrode 7. The sealing member 95 is located opposite to an outer peripheral portion of the shield electrode 6. In the second embodiment, the sealing member 95 overlaps with the shield electrode 6 at the outer peripheral portion thereof.

According to the second embodiment, the liquid crystal display device 100 having the above structure comprises the array substrate 200, a drive circuit 38, a counter-substrate 300, the sealing member 95 and a liquid crystal layer 90. The array substrate 200 includes the trap electrode 7 and the shield electrode 6, which is provided above scanning lines 11. The trap electrode 7, as described above, is formed on the projection portion 31A. The sealing member 95 is located opposite to the entire trap electrode 7. The space for trapping ions can be expanded as in the first embodiment. It is therefore possible to prevent movement of ions into a display area 50, and prevent occurrence of black unevenness.

In the second embodiment, part of the shield electrode 6 is located under the sealing member 95. By virtue of this structure, it is possible to effectively block ions generated in a region which is located outward of the sealing member 95 or the liquid crystal display device 100.

By virtue of the above structure, it is possible to obtain a liquid crystal display device 100 in which ions can be kept out of the display area.

### Third Embodiment

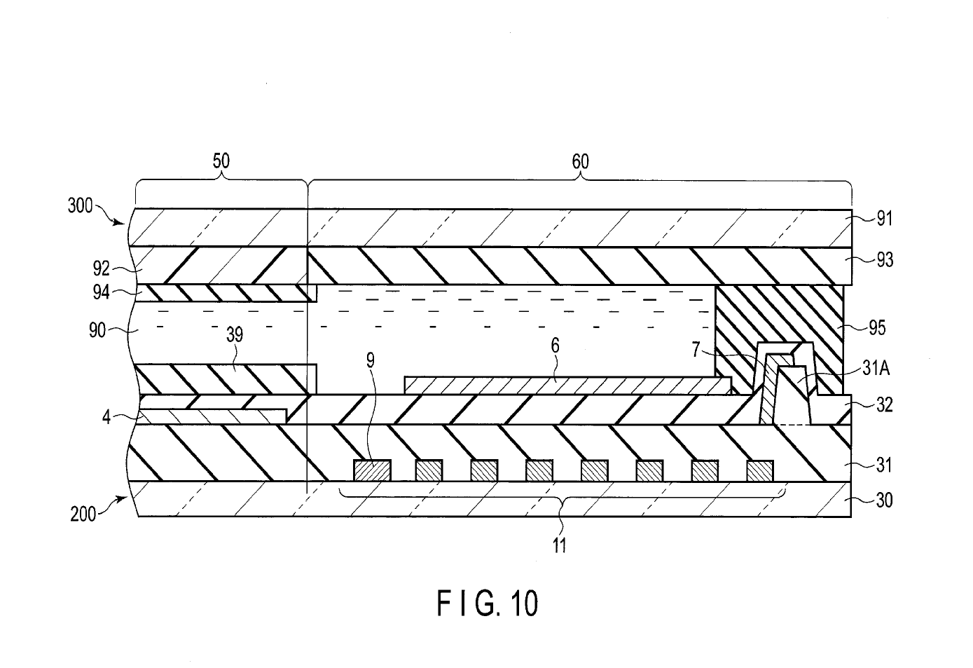

A liquid crystal display device according to the third embodiment will be described. FIG. 10 is a cross-sectional view illustrating a liquid crystal display device 100 according to the third embodiment.

As illustrated in FIG. 10, a trap electrode 7 is formed on a projection portion 31A and entirely opposite to a sealing member 95. A shield electrode 6 is provided on an insulating layer 32, and is expanded toward a trap electrode 7. The sealing member 95 is located opposite to an outer peripheral portion of the shield electrode 6. In the third embodiment, the sealing member 95 overlaps with the shield electrode 6 at the outer peripheral portion thereof. A trap electrode 9 is provided in the same layer as scanning lines 11, and the trap electrode 9 and the scanning lines 11 are covered with an insulating layer 31. As seen in plan view, the trap electrode 9 is located closer to a display area 50 than the shield electrode 6.

According to the third embodiment, the liquid crystal display device 100 having the above structure comprises an array substrate 200, a drive circuit 38, a counter-substrate 300, the sealing member 95 and a liquid crystal layer 90. The array substrate 200 includes the trap electrode 7 and the shield electrode 6, which is located above the scanning lines 11. The trap electrode 7 is formed on a projection portion 31A. The sealing member 95 is located opposite to the entire trap electrode 7. The space for trapping ions can be expanded as in the first embodiment. It is therefore possible to prevent movement of ions into the display area 50, and prevent occurrence of black unevenness.

Since part of the shield electrode 6 is located under the sealing member 95, it is possible to effectively block ions generated in a region located outward of the sealing member 95 or the liquid crystal display device 100.

The trap electrode 9, as described above, is located closer to the display area 50 than the shield electrode 6. Therefore, the trap electrode 9 can collect in a non-display area 60, ions existing close to the boundary between the display area 50 and the non-display area 60.

By virtue of the above structure, it is possible to obtain a liquid crystal display device 100 in which ions can be kept out of the display area.

### Fourth Embodiment

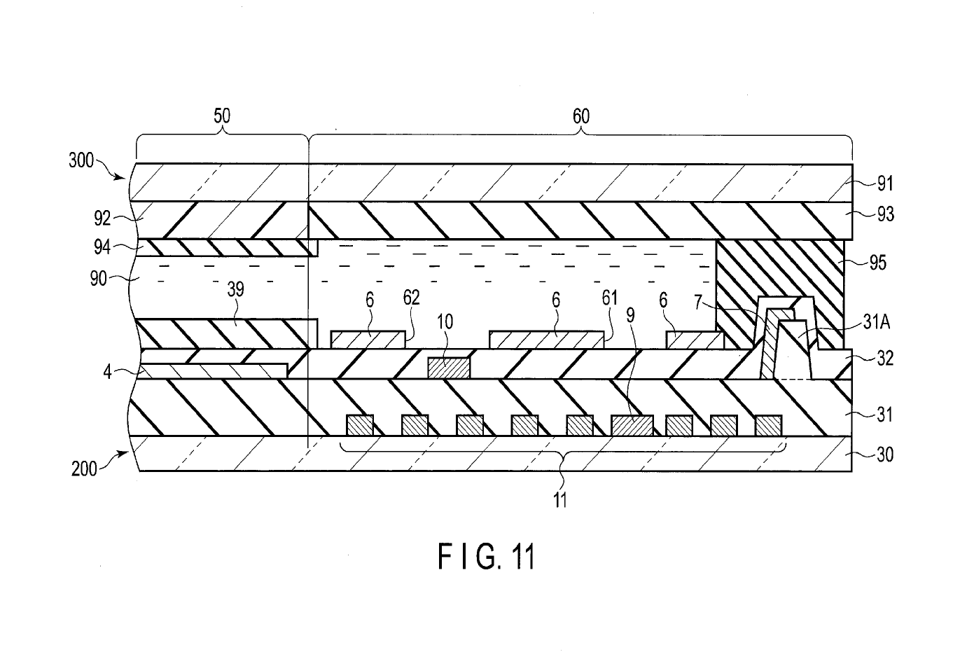

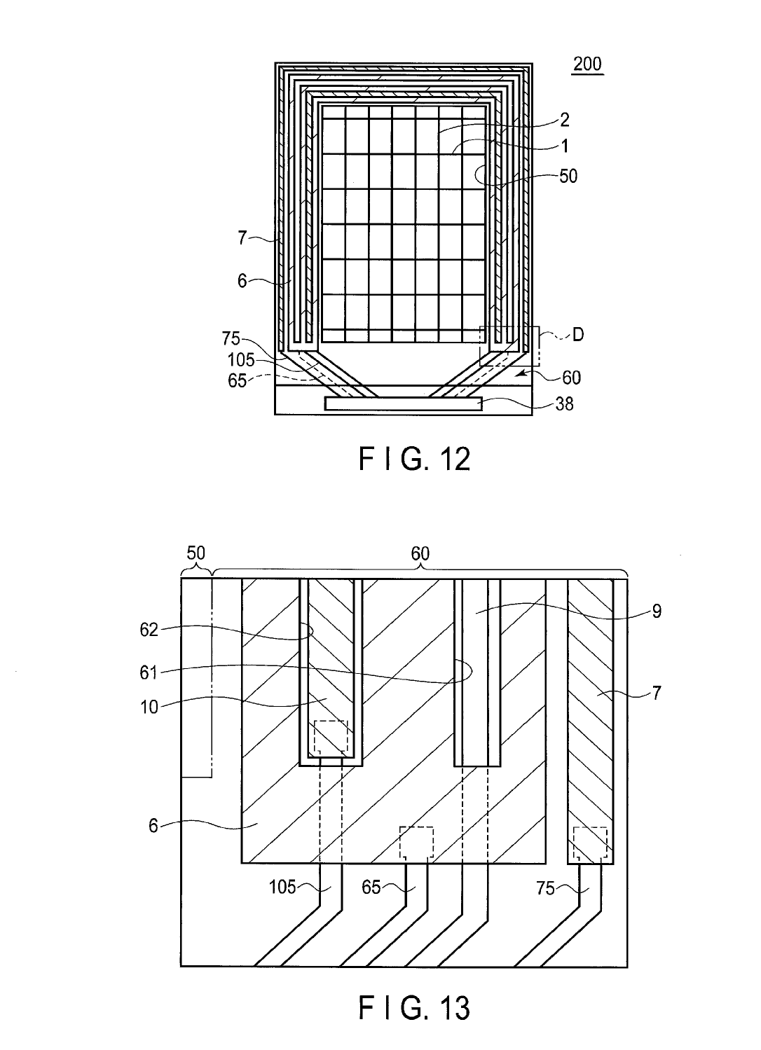

A liquid crystal display device according to the fourth embodiment will be described. FIG. 11 is a cross-sectional view illustrating a liquid crystal display device 100 according to the fourth embodiment. FIG. 12 is a plan view illustrating an array substrate 200 as illustrated in FIG. 11. FIG. 13 is an enlarged plan view illustrating part of the array substrate 200 as illustrated in FIG. 12, i.e., an area D illustrated in FIG. 11.

As illustrated in FIGS. 11, 12 and 13, a trap electrode 7 is provided on a projection portion 31A and entirely opposite to a sealing member 95. A shield electrode 6 is provided on an insulating layer 32, and expanded toward the trap electrode 7. The sealing member 95 is located opposite to an outer peripheral portion of the shield electrode 6. In the third embodiment, the sealing member 95 overlaps with the shield electrode 6 at the outer peripheral portion thereof.

The shield electrode 6 includes openings. In the third embodiments, the shield electrode 6 includes openings 61 and 62. The opening 61 is U-shaped along part of an outer periphery of the shield electrode 6. The opening 62 is also U-shaped along another part of the outer periphery of the shield electrode 6. The opening 62 is closer to a display area 50 than the opening 61.

A trap electrode 9 is provided in the same layer as scanning lines 11, and the trap electrode 9 and the scanning lines 11 are covered with an insulating layer 31. The trap electrode 9 extends such that it is exposed through the opening 61.

The array substrate 200 further includes a trap electrode 10 as a third trap electrode. The trap electrode 10 is provided on part of the insulating layer 31, which is located in a non-display area 60. Also, the trap electrode 10 is provided in the same layer as a common electrode 4. As seen in plan view, the trap electrode 10 is U-shaped along three sides of the non-display area 60. However, the shape of the trap electrode 10 is not limited to U-shape, and can be variously changed. The trap electrode 10 is provided along the opening 62 and above the scanning lines 11, and can be formed of a transparent conductive material such as ITO or metal.

The trap electrode 10 is located under the opening 62. That is, as seen in plan view, the trap electrode 10 is located in the opening 62 of the shield electrode 6. The trap electrode 10 is provided such that it is exposed through the opening 62.

The shield electrode 6 and the trap electrode 10 are provided such that at least part of the shield electrode 6 does not cover the trap electrode 10, as seen plan view. Furthermore, it is preferable that the shield electrode 6 and the trap electrode 10 be separated from each other as seen in plan view. Also, preferably, the width of the trap electrode 10 should be less than that of the opening 62. Since at least part of the shield electrode 6 does not cover the trap electrode 10, as seen in plan view, the shield electrode 6 and the trap electrode 10 can effectively perform their respective functions on ions which are impurities, i.e., the shield electrode 6 can block ions, and the trap electrode 10 can collect ions.

A conductive line 105 connects a drive circuit 38 and the trap electrode 10 to each other. The drive circuit 38 drives the trap electrode 10. The drive circuit 38 causes the potential of the trap electrode 10 to differ from that of the shield electrode 6. In the fourth embodiment, the drive circuit 38 sets the potential of the trap electrode 10 at a lower value than the potential of the shield electrode 6. To be more specific, the drive circuit 38 applies, for example, a gate low voltage which is an off voltage of a switching element 40 to the conductive line 105. The potential of the trap electrode 10 is set less than that of the shield electrode 6.

According to the fourth embodiment, the liquid crystal display device 100 comprises the array substrate 200, the drive circuit 38, a counter-substrate 300, the sealing member 95 and a liquid crystal layer 90. The array substrate 200 includes the trap electrode 7 and the shield electrode 6, which is located above the scanning lines 11. The trap electrode 7 is formed on a projection portion 31A. The sealing member 95 is located opposite to the entire trap electrode 7. The space for trapping ions can be expanded as in the first embodiment. It is therefore possible to prevent movement of ions into the display area 50, and prevent occurrence of black unevenness.

Since part of the shield electrode 6 is located under the sealing member 95, it is possible to effectively block ions generated in a region which is located outward of the sealing member 95 or the liquid crystal display device 100.

As seen in plan view, at least portions of the shield electrode 6 and trap electrode 9 are not opposite to each other, and also at least portions of the shield electrode 6 and trap electrode 10 are not opposite to each other, whereby the shield electrode 6 and the trap electrodes 9 and 10 can effectively perform their functions on ions which are impurities, i.e., the shield electrode 6 can block ions, and the trap electrodes 9 and 10 can collect ions.

By virtue of the above structure, it is possible to obtain a liquid crystal display device 100 in which ions can be kept out of the display area.

### Fifth Embodiment

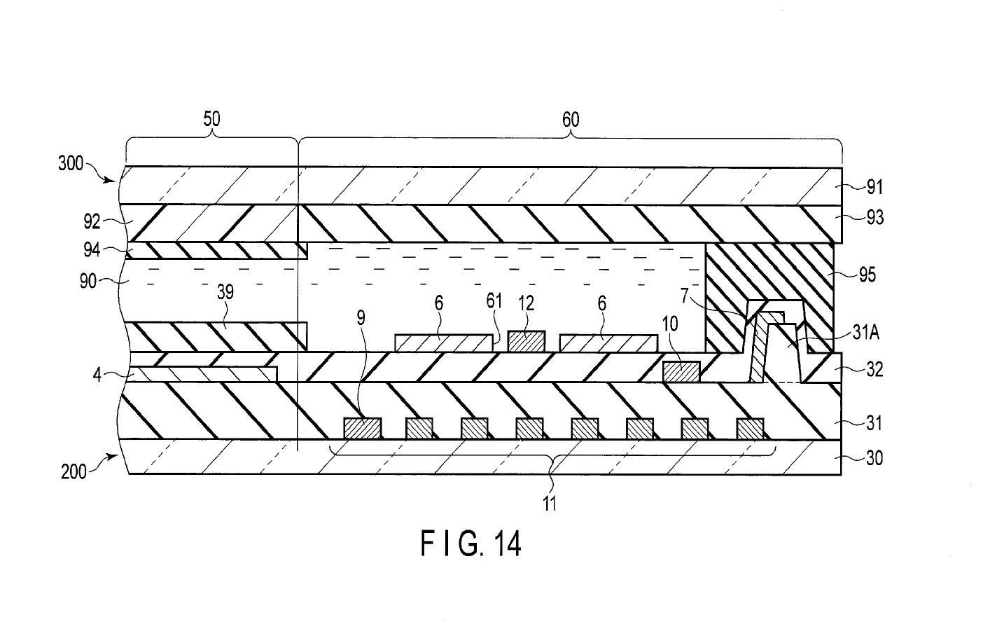

A liquid crystal display device according to the fifth embodiment will be described. FIG. 14 is a cross-sectional view illustrating a liquid crystal display device 100 according to the fifth embodiment.

As illustrated in FIG. 14, a trap electrode 7 is formed on a projection portion 31A and entirely opposite to a sealing member 95. Furthermore, a shield electrode 6 is provided on an insulating layer 32, and includes an opening 61. As seen in plan view, the shield electrode 6 is separated from the sealing member 95. A trap electrode 9 is provided in the same layer as scanning lines 11, and the trap electrode 9 and the scanning lines 11 are covered with an insulating layer 31. As seen in plan view, the trap electrode 9 is located closer to a display area 50 than an inner peripheral portion of the shield electrode 6.

A trap electrode 10 is provided in the same layer as a common electrode 4, and the trap electrode 10 and the common electrode 4 are covered with the insulating layer 32. Also, as seen in plan view, the trap electrode 10 is located between the shield electrode 6 and the trap electrode 7. In the fifth embodiment, the trap electrode 10 is located between an outer edge portion of the shield electrode 6 and an inner peripheral wall of the sealing member 95. The trap electrode 10 can be formed of the same conductive material (for example, ITO) as the common electrode 4. Since the trap electrode 10 is provided in the same layer as the common electrode 4, when the liquid crystal display device 100 is manufactured, the common electrode 4 and the trap electrode 10 can be formed in a simple step.

The array substrate 200 further comprises a trap electrode 12 as a fourth trap electrode. The trap electrode 12 is provided on part of the insulating layer 32 which is located in a non-display area 60. The trap electrode 12 is provided in the same layer as the shield electrode 6. Also, the trap electrode 12 is located in the opening 61. As seen in plan view, the trap electrode 12 is U-shaped along the shape of the opening 61. However, the shape of the trap electrode 12 is not limited to U-shape, and can be variously changed. The trap electrode 12 is formed in the following manner; it is provided along the opening 62; it is separated from the opening 61; it is electrically insulated from the shield electrode 6; it is provided above the scanning lines 11; and it can be formed of a transparent conductive material such as ITO or metal. In addition, the trap electrode 12 may be formed of the same material as the shield electrode 6.

Furthermore, the trap electrode 12 is electrically connected to the drive circuit 38 by a conductive line. The drive circuit 38 drives the trap electrode 12. The drive circuit 38 causes the potential of the trap electrode 12 to differ from that of the shield electrode 6. In the fifth embodiment, the drive circuit 38 sets the potential of the trap electrode 12 at a lower voltage than the potential of the shield electrode 6. The drive circuit 38 applies, for example, a gate low voltage which is an off voltage of a switching element 40 to the trap electrode 12, through the conductive line. The potential of the trap electrode 12 is set less than that of the shield electrode 6.

According to the fifth embodiment, the liquid crystal display device 100 having the above structure comprises the array substrate 200, the drive circuit 38, a counter-substrate 300, the sealing member 95 and a liquid crystal layer 90. The array substrate 200 includes the trap electrode 7 and the shield electrode 6, which is located above the scanning lines 11. The trap electrode 7 is formed on a projection portion 31A. The sealing member 95 is located opposite to the entire trap electrode 7. The space for trapping ions can be expanded as in the first embodiment. It is therefore possible to prevent movement of ions into the display area 50, and prevent occurrence of black unevenness.

As seen in plan view, at least portions of the shield electrode 6 and trap electrode 9 are not opposite to each other, at least portions of the shield electrode 6 and trap electrode 10 are not opposite to each other, and also at least portions of the shield electrode 6 and trap electrode 12 are not opposite to each other, whereby the shield electrode 6 and the trap electrodes 9, 10 and 12 can effectively perform their functions on ions which are impurities, i.e., the shield electrode 6 can block ions, and the trap electrodes 9, 10 and 12 can collect ions.

The trap electrode 12 is provided in the same layer as an alignment film 39. Thus, the trap electrode 12 can effectively collect ions produced from the alignment film 39. Furthermore, the trap electrode 12 is provided on the insulating layer 32. That is, the trap electrode 12 is provided close to the liquid crystal layer 90. Thereby, the trap electrode 12 can effectively collect ions produced from the liquid crystal layer 90.

Furthermore, the shield electrode 6 and the trap electrode 12 are provided in the same layer. Thereby, when the liquid crystal display device 100 is manufactured, the shield electrode 6 and the trap electrode 12 can be manufactured in a simple step.

The trap electrode 9 is located closer to the display area 50 than the shield electrode 6. Thus, the trap electrode 9 can collect in the non-display area 60, ions existing close to the boundary between the display area 50 and the non-display area 60.

By virtue of the above structure, it is possible to obtain a liquid crystal display device 100 in which ions can be kept out of the display area.

### Sixth Embodiment

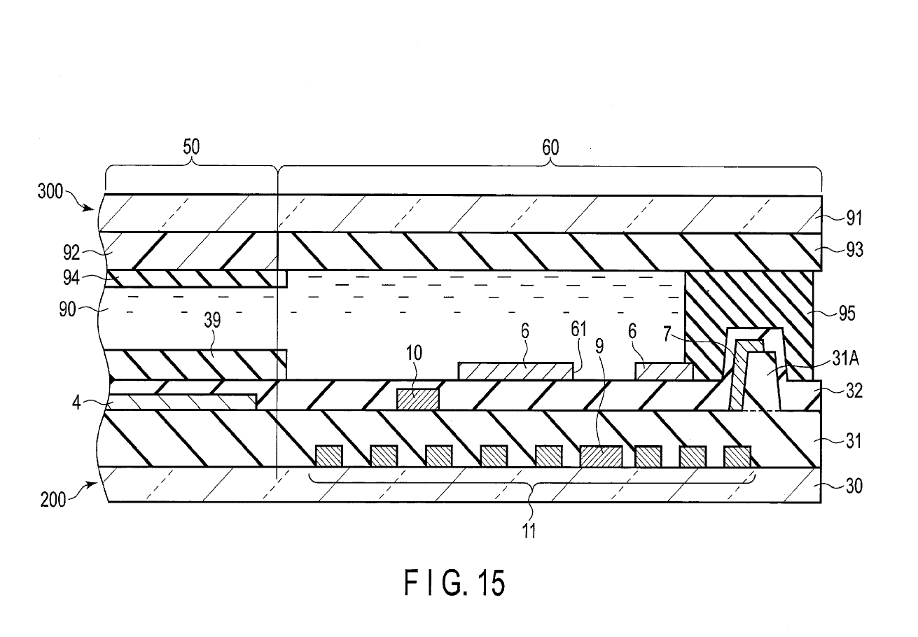

A liquid crystal display device according to the sixth embodiment will be described. FIG. 15 is a cross-sectional view illustrating a liquid crystal display device 100 according to the sixth embodiment.

As illustrated in FIG. 15, a trap electrode 7 is formed on a projection portion 31A and entirely opposite to a sealing member 95. A shield electrode 6 is provided on an insulating layer 32, and is expanded toward a trap electrode V. The sealing member 95 is located opposite to an outer peripheral portion of the shield electrode 6. In the sixth embodiment, the sealing member 95 overlaps with the shield electrode 6 at the outer peripheral portion thereof. The shield electrode 6 includes an opening 61. The opening 61 is U-shaped along part of an outer periphery of the shield electrode 6.

A trap electrode 9 is provided in the same layer as scanning lines 11, and the trap electrode 9 and the scanning lines 11 are covered with an insulating layer 31. The trap electrode 9 extends such that it is exposed through the opening 61.

A trap electrode 10 is provided on part of the insulating layer 31, which is located in a non-display area 60, and is covered with the insulating layer 32. Also, the trap electrode 10 is provided in the same layer as a common electrode 4. The trap electrode 10 is located closer to a display area 50 than an inner peripheral portion of the shield electrode 6. As seen in plan view, the trap electrode 10 is U-shaped along the shape of the shield electrode 6. However, the shape of the trap electrode 10 is not limited to U-shape, and can be variously changed. The trap electrode 10 is located opposite to the scanning lines 11. The trap electrode 10 can be formed of a transparent conductive material such as ITO or metal.

The shield electrode 6 and the trap electrode 10 are provided such that at least part of the shield electrode 6 does not cover the trap electrode 10 as seen plan view. The shield electrode 6 and the trap electrode 10 are provided such that at least part of the shield electrode 6 does not cover the trap electrode 10 as seen plan view.

According to the sixth embodiment, the liquid crystal display device 100 having the above structure comprises the array substrate 200, a drive circuit 38, a counter-substrate 300, the sealing member 95 and a liquid crystal layer 90. The array substrate 200 includes the trap electrode 7 and the shield electrode 6, which is located above the scanning lines 11. The trap electrode 7 is formed on a projection portion 31A. The sealing member 95 is located opposite to the entire trap electrode 7. The space for trapping ions can be expanded as in the first embodiment. It is therefore possible to prevent movement of ions into the display area 50, and prevent occurrence of black unevenness.

Since part of the shield electrode 6 is located under the sealing member 95, it is possible to effectively block ions produced in a region which is located outward of the sealing member 95 or the liquid crystal display device 100.

As seen in plan view, at least portions of the shield electrode 6 and trap electrode 9 are not opposite to each other, and also at least portions of the shield electrode 6 and trap electrode 10 are not opposite to each other, whereby the shield electrode 6 and the trap electrodes 9 and 10 can effectively perform their functions on ions which are impurities, i.e., the shield electrode 6 can block ions, and the trap electrodes 9 and 10 can collect ions.

The trap electrode 10 is located closer to the display area 50 than the shield electrode 6. Thereby, the trap electrode 10 can collect ions existing close to the boundary between the display area 50 and the non-display area 60, in the non-display area 60.

By virtue of the above structure, it is possible to obtain a liquid crystal display device 100 in which ions can be kept out of the display area.

### Seventh Embodiment

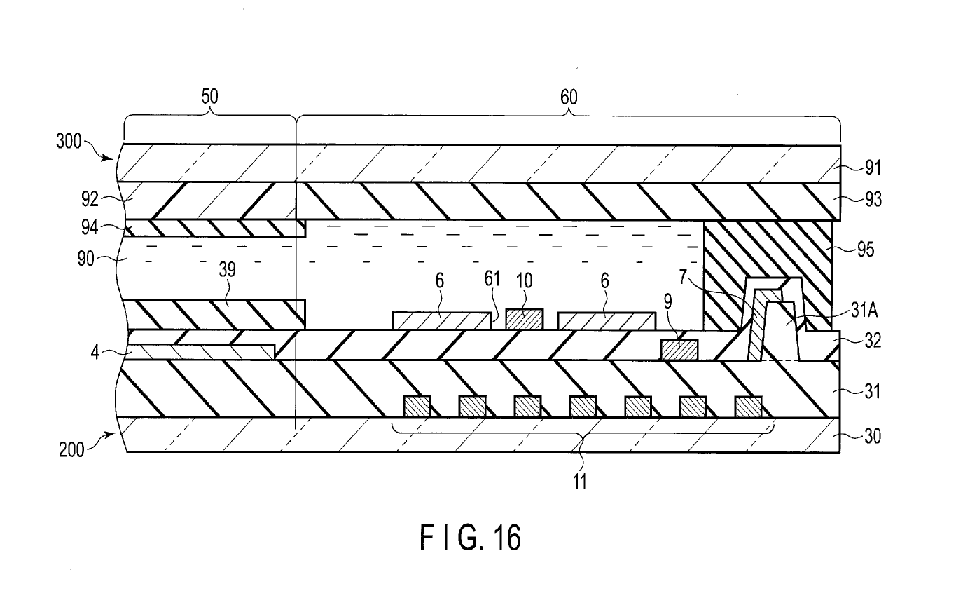

A liquid crystal display device according to the seventh embodiment will be described. FIG. 16 is a cross-sectional view illustrating a liquid crystal display device 100 according to the seventh embodiment.

As illustrated in FIG. 16, a trap electrode 7 is formed on a projection portion 31A and entirely opposite to a sealing member 95. Furthermore, a shield electrode 6 is provided on an insulating layer 32, and includes an opening 61. As seen in plan view, the shield electrode 6 is separated from the sealing member 95.

A trap electrode 9 is provided in the same layer as a common electrode 4, and the trap electrode 9 and the common electrode 4 are covered with the insulating layer 32. Also, as seen in plan view, the trap electrode 9 is located between the shield electrode 6 and the trap electrode 7. In the seventh embodiment, the trap electrode 9 is located between an outer edge portion of the shield electrode 6 and an inner peripheral wall of the sealing member 95. The trap electrode 9 can be formed of the same conductive material (for example, ITO) as the common electrode 4. Since the trap electrode 9 is provided in the same layer as the common electrode 4, when the liquid crystal display device 100 is manufactured, the common electrode 4 and the trap electrode 9 can be formed in a simple step.

The trap electrode 10 is provided on part of the insulating layer 32 which is located in a non-display area 60. The trap electrode 10 is provided in the same layer as the shield electrode 6. Also, the trap electrode 10 is located in the opening 61. As seen in plan view, the trap electrode 10 is U-shaped along the shape of the opening 61. However, the shape of the trap electrode 10 is not limited to U-shape, and can be variously changed. The trap electrode 10 is formed in the following manner; it is provided along the opening 61; it is separated from the opening 61; it is electrically insulated from the shield electrode 6; and it is provided above scanning lines 11. The trap electrode 10 can be formed of a transparent conductive material such as ITO or metal. Furthermore, the trap electrode 10 and the shield electrode 6 may be formed of the same conductive material.

According to the seventh embodiment, the liquid crystal display device 100 having the above structure comprises an array substrate 200, a drive circuit 38, a counter-substrate 300, the sealing member 95 and a liquid crystal layer 90. The array substrate 200 includes the trap electrode 7 and the shield electrode 6, which is located above the scanning lines 11. The trap electrode 7 is formed on a projection portion 31A. The sealing member 95 is located opposite to the entire trap electrode 7. The space for trapping ions can be expanded as in the first embodiment. It is therefore possible to prevent movement of ions into a display area 50, and prevent occurrence of black unevenness.

As seen in plan view, at least portions of the shield electrode 6 and trap electrode 9 are not opposite to each other, and also at least portions of the shield electrode 6 and trap electrode 10 are not opposite to each other, whereby the shield electrode 6 and the trap electrodes 9 and 10 can effectively perform their functions on ions which are impurities, i.e., the shield electrode 6 can block ions, and the trap electrodes 9 and 10 can collect ions.

The trap electrode 10 is provided in the same layer as an alignment film 39. Thereby, the trap electrode 10 can effectively collect ions produced from the alignment film 39. Furthermore, the trap electrode 10 is provided on the insulating layer 32. That is, the trap electrode 10 is provided close to the liquid crystal layer 90. Thereby, the trap electrode 10 can effectively collect ions produced from the liquid crystal layer 90.

Furthermore, the shield electrode 6 and the trap electrode 10 are provided in the same layer. Thereby, when the liquid crystal display device 100 is manufactured, the shield electrode 6 and the trap electrode 10 can be manufactured in a simple step.

By virtue of the above structure, it is possible to obtain a liquid crystal display device 100 in which ions can be kept out of the display area.

### Eighth Embodiment

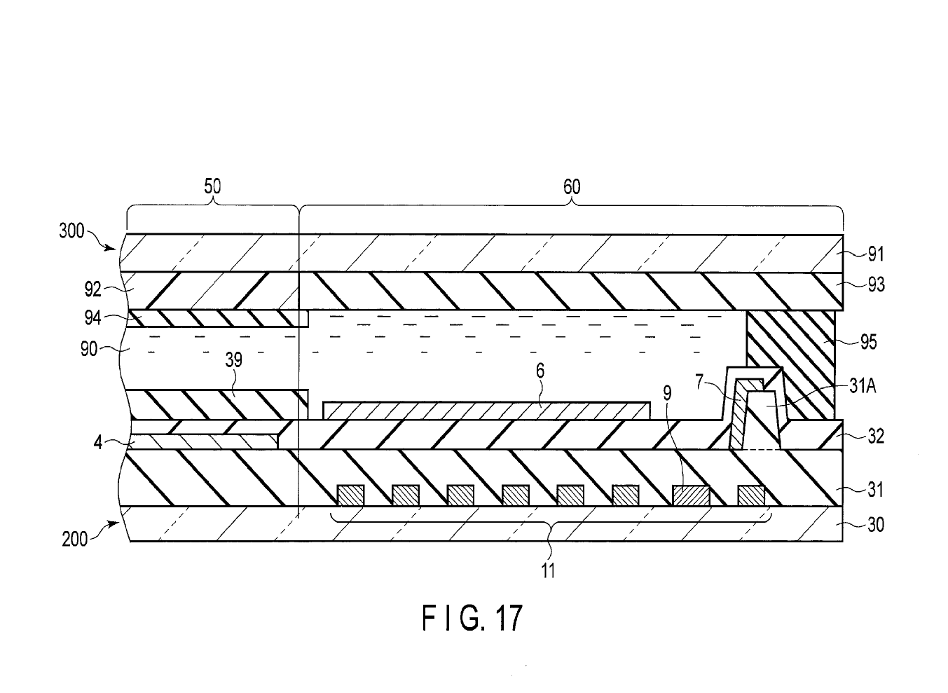

A liquid crystal display device according to the eighth embodiment will be described. FIG. 17 is a cross-sectional view illustrating a liquid crystal display device 100 according to the eighth embodiment.

As illustrated in FIG. 17, the liquid crystal display device 100 according to the eighth embodiment is different from that according to the first embodiment regarding the position of a sealing member 95 with respect to a trap electrode 7. The sealing member 95 is located opposite to at least part of the trap electrode 7, not the entire trap electrode 7. The sealing member 95 is located opposite to an outer edge portion of the trap electrode 7.

According to the eighth embodiment, the liquid crystal display device 100 having the above structure comprises an array substrate 200, a drive circuit 38, a counter-substrate 300, the sealing member 95 and a liquid crystal layer 90. The array substrate 200 includes the trap electrode 7 and a shield electrode 6 located above scanning lines 11. The trap electrode 7 is formed on a projection portion 31A.

The sealing member 95 is located opposite to at least part of the trap electrode 7. In this regard, the eighth embodiment is the same as the first embodiment. Therefore, the eighth embodiment can obtain the same advantage as the first embodiment.

By virtue of the above structure, it is possible to obtain a liquid crystal display device 100 in which ions can be kept out of the display area.

### Ninth Embodiment

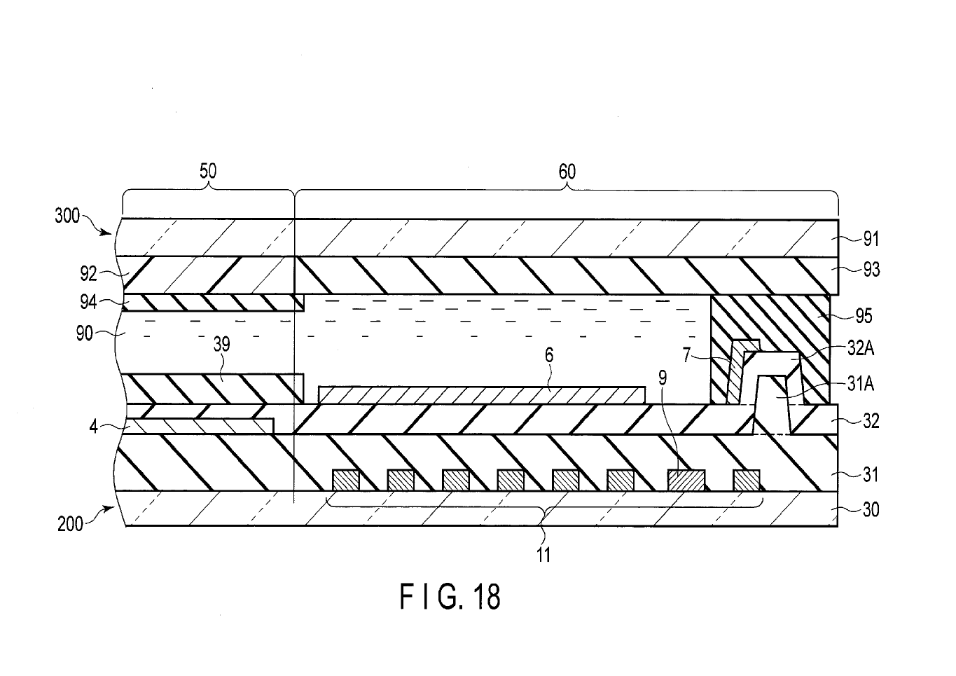

A liquid crystal display device according to the ninth embodiment will be described. FIG. 18 is a cross-sectional view illustrating a liquid crystal display device 100 according to the ninth embodiment.

As illustrated in FIG. 18, the liquid crystal display device 100 according to the ninth embodiment is different from that according to the first embodiment regarding the position of a trap electrode 7. In a non-display area 60, an insulating layer 32 includes a projection portion 32A as a second projection portion. The projection portion 32A is stacked on the projection portion 31A. The projection portion 32A is formed in such a way as to protrude in accordance with the shape of the projection portion 31A. For example, the projection portion 32A is U-shaped as seen plan view. The trap electrode 7 is provided above the projection portion 31A. Also, the trap electrode 7 is provided on the projection portion 32A. Furthermore, the trap electrode 7 is continuously formed from an upper surface of the projection portion 32A to a wall surface of the projection portion 32A which faces the display area 50. Thus, the trap electrode 7 can be formed along the projection portion 32A. In the ninth embodiment, the projection portion 32A and the trap electrode 7 are covered with a sealing member 95.

According to the ninth embodiment, the liquid crystal display device 100 having the above structure comprises an array substrate 200, a drive circuit 38, a counter-substrate 300, the sealing member 95 and a liquid crystal layer 90. The array substrate 200 includes the trap electrode 7 and a shield electrode 6 located above scanning lines 11. The sealing member 95 is located opposite to the entire trap electrode 7.

The trap electrode 7, as described above, is provided on the projection portion 32A. Also, the trap electrode 7 is provided above the projection portion 31A. In this regard, the ninth embodiment is the same as the first embodiment. Therefore, the ninth embodiment can obtain the same advantage as the first embodiment.

By virtue of the above structure, it is possible to obtain a liquid crystal display device 100 in which ions can be kept out of the display area.

### Tenth Embodiment

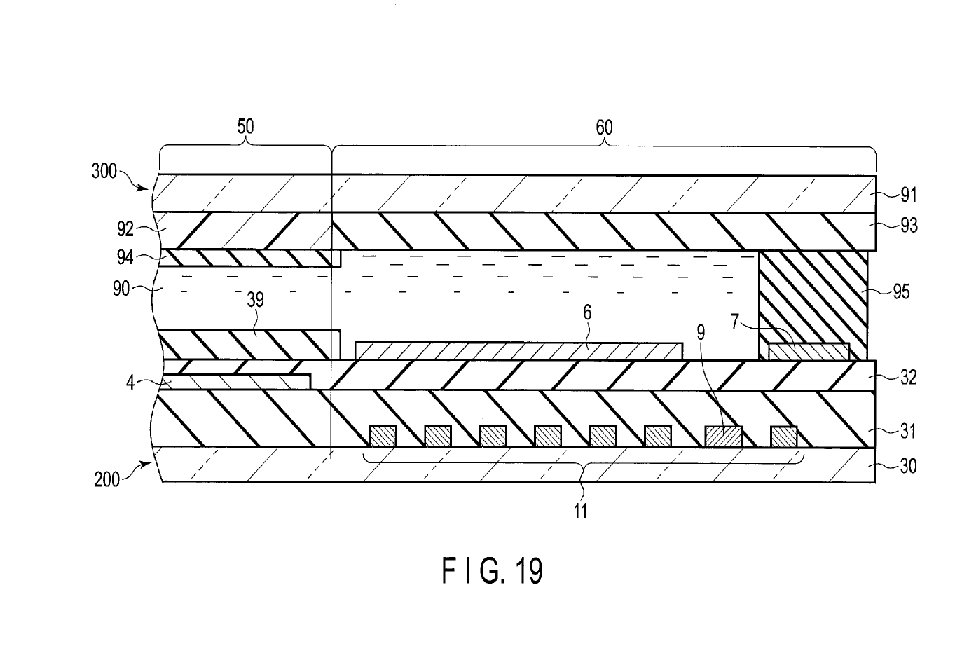

A liquid crystal display device according to the tenth embodiment will be described. FIG. 19 is a cross-sectional view illustrating a liquid crystal display device 100 according to the tenth embodiment.

As illustrated in FIG. 19, in the liquid crystal display device 100 according to the tenth embodiment, no projection portion 31A is formed. In this regard, the tenth embodiment is different from the first embodiment. An insulating layer 31 is formed such that part of the insulating layer 31 which is located in a display area 50 has the same thickness as part of the insulating layer 31 which is located in a non-display area 60.

A trap electrode 7 is formed on a surface of the insulating layer 31 on which no projection portion 31A is formed. A surface of part of the insulating layer 31, on which the trap electrode 7 is stacked, is substantially flat. The trap electrode 7 is entirely covered with a sealing member 95.

According to the tenth embodiment, the liquid crystal display device 100 having the above structure comprises an array substrate 200, a drive circuit 38, a counter-substrate 300, a sealing member 95 and a liquid crystal layer 90. The array substrate 200 includes the trap electrode 7 and a shield electrode 6 located above scanning lines 11. The sealing member 95 is located opposite to the entire trap electrode 7. The trap electrode 7, as described above, is stacked on the above substantially flat surface of the insulating layer 32. At least part of the trap electrode 7 is located opposite to the sealing member 95. This is the same as the first embodiment. In the tenth embodiment, the entire trap electrode 7 is located opposite to the sealing member 95. In this regard, the tenth embodiment is the same as the first embodiment. Therefore, the tenth embodiment can obtain the same advantages as the first embodiment.

By virtue of the above structure, it is possible to obtain a liquid crystal display device 100 in which ions can be kept out of the display area.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, with respect to the shield electrode 6, it suffices that in the non-display area 60, the shield electrode 6 is located above the scanning lines 11 and opposite to the scanning lines 11. Thus, the shield electrode 6 may be formed on the insulating layer 31, not the insulating layer 32. Also, in the case where the shield electrode 6 is formed on the insulating layer 31, part of the shield electrode 6 may be located opposite to the sealing member 95.

The array substrate 200 may include a plurality of shield electrodes. For example, the array substrate 200 may include a second shield electrode, in addition to the shield electrode 6. In the case of using the shield electrode 6 and the second shield electrode, for example, it may be set that the shield electrode 6 is formed on the insulating layer 32, and the second shield electrode is formed on the insulating layer 31. The drive circuit 38 can further drive the second shield electrode, set the potential of the second shield electrode such that it is equal to that of the shield electrode 6, and set the potential of the trap electrode such that it is different from those of the shield electrode 6 and the second shield electrode.

Furthermore, the array substrate 200 may include only the trap electrode 7 as its trap electrode. Alternatively, as described with respect to the above embodiments, in addition to the trap electrode 7, the array substrate 200 may further include another trap electrode.

In the non-display area 60, one or more trap electrodes may be provided closer to the display area 50 than the shield electrode (the shield electrode 6). In this case, the trap electrode may be provided in any layer. That is, it can be provided in the same layer as the scanning lines 11 or it can be formed on the insulating layer 31 or on the insulating layer 32. In the case where a plurality of trap electrodes are provided closer to the display area 50 than the shield electrode, they may be provided in the same layer or they may be dividedly provided in different layers.

In the case where the shield electrode includes the above opening as explained with reference to the embodiments, one or more trap electrodes may be provided in the opening as seen in plan view. With respect to the trap electrode, it suffices that at least part of the trap electrode is provided in the opening. Also, the trap electrode may be provided in any layer; that is, it can be provided in the same layer as the scanning lines 11, or it can be provided on the insulating layer 31 or on the insulating layer 32. In the case where a plurality of trap electrodes are provided in the opening, they may be provided in the same layer or they may be dividedly provided in different layers.

In the where as seen in plan view, in the non-display area 60, a plurality of shield electrodes are spaced from each other, one or more trap electrodes may be provided between the shield electrodes. With respect to the trap electrode, it suffices that at least part of the trap electrode is provided between the shield electrodes. Also, the trap electrode may be provided in any layer; that is, it can be provided in the same layer as the scanning lines 11, or it can be provided on the insulating layer 31 or on the insulating layer 32. In the case where a plurality of trap electrodes are provided between the shield electrodes, they may be provided in the same layer or they may be dividedly provided in different layers.

As illustrated in FIGS. 6, 14, 16, etc., between the shield electrode and the trap electrode 7, another trap electrode may be provided as seen in plan view. However, in this case, the above other trap electrode can be provided in the same layer as the trap electrode 7, or it can be provided at a layer located below or under a layer containing the trap electrode 7. It is not appropriate that the above other trap electrode is provided in a layer which is located above the layer containing the trap electrode 7. For example, referring to FIG. 6, it is not appropriate that the trap electrode 9 is provided on the insulating layer 32. This is because in such a case, the trap electrode 7 cannot easily produce an electric field between the trap electrode 7 and the shield electrode 6.

In the case where the trap electrode 7 is formed on a projection portion, it may be formed only on an upper surface of the projection portion, or it may be formed only on a wall surface of the projection portion which faces the display area 50.

It should be noted that the shield electrode 6 and the trap electrode 7 may be provided on a side of the non-display area 60, on which the drive circuit 38 is provided. Along with the scanning lines 11 in the non-display area 60 or in place of the scanning lines 11, the shield electrode and the trap electrode may be provided above the signal lines 21 in the non-display area 60.

It should be noted that the alignment film 39 may be provided in the non-display area 60, and may be provided close to the sealing member 95. In this case, the shield electrode 6 may be provided above the alignment film 39. Also, in this case, the shield electrode 6 may be provided just on the alignment film 39 or just under the alignment film 39. Thereby, it is possible to effectively prevent collection of ions produced from the alignment film 39 provided in the non-display area 60, in the display area 50.

The above embodiments can be applied to various liquid crystal display devices and drive methods thereof. In addition, needless to say, The above embodiments can be applied to middle or small display devices and large display devices without particular limitation.

What is claimed is:

1. A liquid crystal display device comprising:
a first substrate including a display area which displays an image; a non-display area located outward of the display area; a scanning line provided to extend from the display area to the non-display area; a first trap electrode provided in the non-display area; and a first shield electrode provided in the non-display area, located closer to the display area than the first trap electrode, and located above the scanning line;
a drive circuit which drives the scanning line, the first trap electrode and the first shield electrode, and causes a potential of the first trap electrode to differ from a potential of the first shield electrode;
a second substrate located opposite to the first substrate;
a sealing member located in the non-display area and opposite to at least part of the first trap electrode, and joining the first substrate and the second substrate to each other; and
a liquid crystal layer held in space surrounded by the first substrate, the second substrate and the sealing member.

2. The liquid crystal display device of claim 1, wherein
the first substrate further includes a common electrode provided at least in the display area, and
the drive circuit further drives the common electrode, and causes a potential of the common electrode to be equal to the potential of the first shield electrode.

3. The liquid crystal display device of claim 1, wherein
the sealing member is located opposite to an entire of the first trap electrode.

4. The liquid crystal display device of claim 1, wherein
the first substrate further includes a first insulating layer and a second insulating layer formed on the first insulating layer, and
the first trap electrode is formed above the first insulating layer.

5. The liquid crystal display device of claim 4, wherein
the first substrate further includes a first projection portion formed on the first insulating layer and projecting toward the second substrate, and
the first trap electrode is formed above the first projection portion.

6. The liquid crystal display device of claim 5, wherein
the first trap electrode is formed from an upper surface of the first projection portion to a wall surface of the first projection portion which faces the display area, and is covered with the second insulating layer.

7. The liquid crystal display device of claim 5, wherein
the second insulating layer includes a second projection portion stacked on the first projection portion, and
the first trap electrode is formed on the second projection portion.

8. The liquid crystal display device of claim 7, wherein
the first trap electrode is formed from an upper surface of the second projection portion to a wall surface of the second projection portion which faces the display area.

9. The liquid crystal display device of claim 1, wherein
the first substrate further includes a second trap electrode which is provided between the first trap electrode and the first shield electrode, or provided in a position in the non-display area which is closer to the display area than the first shield electrode, and
the drive circuit further drives the second trap electrode, and causes a potential of the second trap electrode to differ from the potential of the first shield electrode.

10. The liquid crystal display device of claim 1, wherein
the first substrate further includes a second shield electrode provided in a position in the non-display area which is closer to the display area than the first shield electrode, and a second trap electrode provided between the first shield electrode and the second shield electrode, and
the drive circuit further drives the second shield electrode and the second trap electrode; and causes a potential of the second shield electrode to be equal to the potential of the first shield electrode, and cause a potential of the second trap electrode to differ from the potentials of the first shield electrode and the second shield electrode.

11. The liquid crystal display device of claim 1, wherein
the drive circuit sets the potential of the first trap electrode at a lower value than the potential of the first shield electrode.
